(19) United States
(12) Patent Application Publication
(10) Pub. No.: US 2024/0169116 A1
(43) Pub. Date: May 23, 2024

(54) PROTECTING DATA SOURCES FROM DIFFERENT ENTITIES FOR SEMICONDUCTOR YIELD RELATED APPLICATIONS

(71) Applicant: KLA Corporation, Milpitas, CA (US)

(72) Inventors: Brian Duffy, San Jose, CA (US); Kris Bhaskar, San Jose, CA (US)

(21) Appl. No.: 18/334,357

(22) Filed: Jun. 13, 2023

Related U.S. Application Data
(60) Provisional application No. 63/427,089, filed on Nov. 21, 2022.

(51) Int. Cl. G06F 30/20; G06F 30/3308

(52) U.S. Cl. CPC G06F 30/20; G06F 30/3308

(57) ABSTRACT

Methods and systems for performing functions with protected data sources from different entities are provided. One system includes a virtual system coupled to an actual system to thereby receive output generated by the actual system for a physical version of the specimen while the specimen is disposed within the actual system. The virtual system includes at least a computer system and a storage medium. The virtual system is not capable of having the physical version of the specimen disposed therein. The virtual system is configured for performing one or more functions for the specimen with two or more protected data sources from two or more different entities, respectively. The virtual system is also configured for performing a virtual version of a process capable of being performed by the actual system for the physical version of the specimen.

### BACKGROUND OF THE INVENTION

### 1. Field of the Invention

This invention generally relates to methods and systems for performing one or more functions with protected data sources from different entities.

### 2. Description of the Related Art

The following description and examples are not admitted to be prior art by virtue of their inclusion in this section.

Fabricating semiconductor devices such as logic and memory devices typically includes processing a substrate such as a semiconductor wafer using a large number of semiconductor fabrication processes to form various features and multiple levels of the semiconductor devices. For example, lithography is a semiconductor fabrication process that involves transferring a pattern from a reticle to a resist arranged on a semiconductor wafer. Additional examples of semiconductor fabrication processes include, but are not limited to, chemical-mechanical polishing (CMP), etch, deposition, and ion implantation. Multiple semiconductor devices may be fabricated in an arrangement on a single semiconductor wafer and then separated into individual semiconductor devices.

Inspection processes are used at various steps during a semiconductor manufacturing process to detect defects on specimens to drive higher yield in the manufacturing process and thus higher profits. Inspection has always been an important part of fabricating semiconductor devices. However, as the dimensions of semiconductor devices decrease, inspection becomes even more important to the successful manufacture of acceptable semiconductor devices because smaller defects can cause the devices to fail.

Defect review typically involves re-detecting defects detected as such by an inspection process and generating additional information about the defects at a higher resolution using either a high magnification optical system or a scanning electron microscope (SEM). Defect review is therefore performed at discrete locations on specimens where defects have been detected by inspection. The higher resolution data for the defects generated by defect review is more suitable for determining attributes of the defects such as profile, roughness, more accurate size information, etc. Defects can generally be more accurately classified into defect types based on information determined by defect review compared to inspection.

Metrology processes are also used at various steps during a semiconductor manufacturing process to monitor and control the process. Metrology processes are different than inspection processes in that, unlike inspection processes in which defects are detected on a specimen, metrology processes are used to measure one or more characteristics of the specimen that cannot be determined using currently used inspection tools. For example, metrology processes are used to measure one or more characteristics of a specimen such as a dimension (e.g., line width, thickness, etc.) of features formed on the specimen during a process such that the performance of the process can be determined from the one or more characteristics. In addition, if the one or more characteristics of the specimen are unacceptable (e.g., out of a predetermined range for the characteristic(s)), the measurements of the one or more characteristics of the specimen may be used to alter one or more parameters of the process such that additional specimens manufactured by the process have acceptable characteristic(s).

Metrology processes are also different than defect review processes in that, unlike defect review processes in which defects that are detected by inspection are re-visited in defect review, metrology processes may be performed at locations at which no defect has been detected. In other words, unlike defect review, the locations at which a metrology process is performed on a specimen may be independent of the results of an inspection process performed on the specimen. In particular, the locations at which a metrology process is performed may be selected independently of inspection results. In addition, since locations on the specimen at which metrology is performed may be selected independently of inspection results, unlike defect review in which the locations on the specimen at which defect review is to be performed cannot be determined until the inspection results for the specimen are generated and available for use, the locations at which the metrology process is performed may be determined before an inspection process has been performed on the specimen.

The objective for semiconductor manufacturers is to repeatedly produce wafers, chips, packages, subsystems, etc. that will predictably meet final use case objectives while minimizing waste by maximizing yield at every step of the value chain. The final arbiter of success is electrical behavior (functionality at a performance specification) of the circuit (determined by solid state physics) over time (reliability under operational conditions).

The root of the problem in currently used semiconductor fabrication related methods and systems is the disaggregation of the semiconductor value chain that has been essential to the economic growth of the industry. The revolution in design decoupling from manufacturing enabled in the early 1980's gave way to the foundry, fabless, electronic design automation (EDA), and semiconductor capital equipment segments of the economy that we have today. As a result of this, each segment can be economically optimized largely based on market forces. Since its inception, the semiconductor value chain has evolved into a complex multi-national network of specialized sub-segments, each with their own shareholder value optimization obligations. There are natural consequences for this segmentation related to intellectual property (IP) protection that occur at the boundaries of companies that are each obligated to maximize their own shareholder value. As a result, there is a great deal of “friction” (and often outright blockage) in the flow of data that is technically required to monitor, diagnose, optimize, and control the complex myriad of process steps involved in making semiconductor-based products. To further complicate matters, as Moore's law lurches forward, the barriers of process, metrology, and inspection physics are challenged.

Accordingly, it would be advantageous to develop systems and/or methods for performing one or more functions with protected data sources from different entities that do not have one or more of the disadvantages described above.

### SUMMARY OF THE INVENTION

The following description of various embodiments is not to be construed in any way as limiting the subject matter of the appended claims.

One embodiment relates to a system configured for performing one or more functions with protected data sources from different entities. The system includes a virtual system coupled to an actual system to thereby receive output generated by the actual system for a physical version of a specimen while the specimen is disposed within the actual system. The virtual system includes at least a computer system and a storage medium. The virtual system is not capable of having the physical version of the specimen disposed therein. The virtual system is configured for performing one or more functions for the specimen with two or more protected data sources from two or more different entities. The virtual system is also configured for performing a virtual version of a process capable of being performed by the actual system for the physical version of the specimen. The system may be further configured as described herein.

Another embodiment relates to a computer-implemented method for performing one or more functions with protected data sources from different entities. The method includes performing one or more functions for a specimen with two or more protected data sources from two or more different entities, respectively. The method also includes performing a virtual version of a process capable of being performed by an actual system with output generated by the actual system for a physical version of the specimen while the specimen is disposed within the actual system. The one or more functions and the virtual version of the process are performed by a virtual system coupled to the actual system to thereby receive the output generated by the actual system for the physical version of the specimen. The virtual system includes at least a computer system and a storage medium. The virtual system is not capable of having the physical version of the specimen disposed therein.

The method may be performed as described further herein. In addition, the method may include any other step(s) of any other method(s) described herein. Furthermore, the method may be performed by any of the systems described herein.

An additional embodiment relates to a non-transitory computer-readable medium storing program instructions executable on a computer system for performing one or more functions with protected data sources from different entities. The computer-implemented method includes the steps of the method described above. The computer-readable medium may be further configured as described herein. The steps of the computer-implemented method may be performed as described further herein. In addition, the computer-implemented method for which the program instructions are executable may include any other step(s) of any other method(s) described herein.

### BRIEF DESCRIPTION OF THE DRAWINGS

Other objects and advantages of the invention will become apparent upon reading the following detailed description and upon reference to the accompanying drawings in which:

FIG. 1 is a schematic diagram illustrating a side view of an embodiment of a system configured as described herein;

FIG. 2 is a block diagram illustrating an embodiment of a system configured as described herein;

FIGS. 3-8 are flow charts illustrating embodiments of performing one or more functions for a specimen with protected data sources from different entities and/or performing a virtual version of a process for the specimen; and

FIG. 9 is a block diagram illustrating one embodiment of a non-transitory computer-readable medium storing program instructions executable on a computer system for performing one or more of the computer-implemented methods described herein.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

The terms “design” and “design data” as used herein generally refer to the physical design (layout) of an IC and data derived from the physical design through complex simulation or simple geometric and Boolean operations. In addition, an image of a reticle acquired by a reticle inspection system and/or derivatives thereof can be used as a “proxy” or “proxies” for the design. Such a reticle image or a derivative thereof can serve as a substitute for the design layout in any embodiments described herein that use a design. The design may include any other design data or design data proxies described in commonly owned U.S. Pat. No. 7,570,796 issued on Aug. 4, 2009 to Zafar et al. and U.S. Pat. No. 7,676,077 issued on Mar. 9, 2010 to Kulkarni et al., both of which are incorporated by reference as if fully set forth herein. In addition, the design data can be standard cell library data, integrated layout data, design data for one or more layers, derivatives of the design data, and full or partial chip design data.

In general, however, the design information or data cannot be generated by imaging a wafer with a wafer inspection system. For example, the design patterns formed on the wafer may not accurately represent the design for the wafer and the wafer inspection system may not be capable of generating images of the design patterns formed on the wafer with sufficient resolution such that the images could be used to determine information about the design for the wafer. Therefore, in general, the design information or design data cannot be generated using a physical wafer. In addition, the “design” and “design data” described herein refers to information and data that is generated by a semiconductor device designer in a design process and is therefore available for use in the embodiments described herein well in advance of printing of the design on any physical wafers.

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals. Unless otherwise noted herein, any of the elements described and shown may include any suitable commercially available elements.

One embodiment relates to a system configured for performing one or more functions with protected data sources from different entities. The novelty of the embodiments described herein is, at least in part, that they are configured for mitigating the concerns of protected data source stakeholders whose cooperation is required for making their data available for use in the functions described further herein. Data security is ensured by the embodiments described herein through a combination of physical, electrical, and algorithmic techniques.

In one embodiment, the specimen includes a wafer. The wafer may include any wafer known in the semiconductor arts. Although some embodiments may be described herein with respect to a wafer or wafers, the embodiments are not limited in the specimen for which they can be used. For example, the embodiments described herein may be used for specimens such as reticles, flat panels, personal computer (PC) boards, and other semiconductor specimens.

The system includes a virtual system coupled to an actual system to thereby receive output generated by the actual system for a physical version of a specimen while the specimen is disposed within the actual system. In general, “actual systems” as that term is used herein refers to systems that perform a process, i.e., an actual process, on or using an actual, physical specimen. In contrast, a “virtual system” as that term is used herein refers to a system that performs a process, i.e., a virtual process, for a specimen without using or interacting with the actual, physical specimen.

The system may or may not include the actual system that is configured to perform one or more processes on the specimen while the specimen is disposed within the actual system to thereby generate the output for the specimens. In general, the one or more processes performed on the specimen by the actual system are yield control-related processes such as inspection, review, metrology, testing, and the like. The processes performed by the actual system are not meant to include processes that are performed by reticle or wafer fabrication tools that alter one or more characteristics of the reticle or wafer. For example, a wafer removed from a wafer inspection tool will have substantially the same characteristics as it did when it was placed inside the wafer inspection tool (unless, of course, something goes terribly wrong). However, there may be some instances in which a yield-control related process may alter one or more characteristics of the specimen, but those characteristics that are altered are not meant to alter the function of devices being formed on or with the specimen. For example, intentional “burn marks” may be left by a scanning electron microscope (SEM) to aid in subsequent relocation of a specific point. In contrast, a wafer removed from a fabrication tool will typically have different characteristics (physical, chemical, and the like) than it did when it was placed inside the fabrication tool (again, unless something goes wrong such as process fail) that will alter the characteristic(s) of devices being formed on or with the specimen.

Since the actual system performs one or more processes on the specimen while the specimen is disposed within the actual system, the actual system will include some sort of specimen handling device or subsystem (such as a stage, a motor driving the stage, a wafer or reticle handling robot, etc.). The specimen handling device or subsystem will generally control the position of the specimen within the actual system. In this manner, the actual systems described herein are configured to perform process(es) on the physical specimen itself, which is in contrast to the virtual systems described further herein that do not interact with the physical specimens even though they can perform one or more functions for the physical specimens.

Performing one or more processes on the specimen with the actual system will generally cause some output (e.g., images, data, image data, signals, image signals, etc.) to be generated by the actual system. For example, during a process, a detector or sensor of an actual system may generate one or more images of a specimen. The actual system may also include one or more computer subsystems that perform some function, algorithm, or method on the output generated by the one or more detectors or sensors of the actual system. For example, a computer subsystem of an actual system may perform defect detection for a specimen using output generated by a detector of the actual system. The results of that defect detection or any other function, method, or algorithm may also be output from the actual system as described further herein. Therefore, the actual system described herein may produce a variety of output, all or only some of which may be received by a virtual system as described further herein.

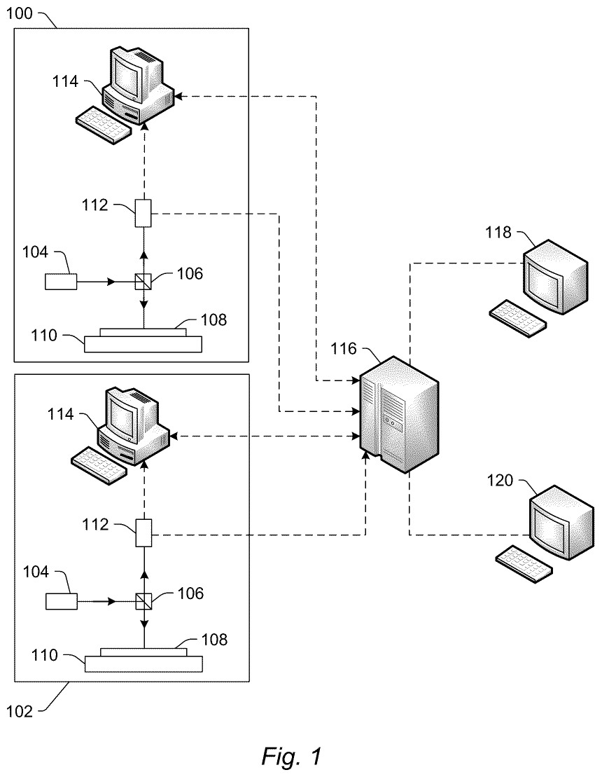

The virtual system may be coupled to only one actual system or more than one actual system. If the virtual system is coupled to more than one actual system, the actual systems may include two of the same systems. For example, as shown in FIG. 1, the system may include two actual systems 100 and 102. Each of the two actual systems includes light source 104 configured to generate light. The actual systems also include beam splitter 106 that is configured to direct light from the light source to specimen 108. Specimen 108 is supported within each of the actual systems by stage 110. Light reflected, scattered, diffracted, or otherwise returned from the specimen may be transmitted by beam splitter 106 to detector 112, which is included in each of the actual systems. The detectors are configured to generate output such as images, image data, signals, or any other suitable output responsive to the light detected by the detectors.

The output of the detectors may be received by computer subsystems 114 included in each of the actual systems. Computer subsystems 114 may be coupled to each of the detectors in any suitable manner. The computer subsystems may be configured to determine one or more characteristics of the specimen using the output of the detectors. The one or more characteristics that are determined by the computer subsystems will vary depending on the configuration of the actual systems and the specimens on which an actual process is being performed.

The actual systems shown in FIG. 1, therefore, have the same configuration and therefore may be the same type of system. The actual systems may however include two systems having different configurations. For example, any of the elements of the actual systems shown in FIG. 1 may be selected to be different. In one such example, the actual systems may have different types of light sources, may be configured to perform one or more processes on different specimens, may have different detectors, etc. In general, the actual systems coupled to the virtual system may include any type of actual systems in any numbers and combinations. In addition, the actual systems may each be configured as physically separated systems, which may be coupled by other hardware or software as described further herein.

FIG. 1 is provided herein to generally illustrate one configuration of actual systems that may be coupled to the virtual system in the embodiments described herein. Obviously, the actual system configurations described herein may be altered to optimize the performance of the actual systems as is normally performed when designing a yield control-related system for the specimens described herein. In addition, the systems described herein may be implemented using existing actual systems (e.g., by adding functionality described herein to existing actual systems) such as the tools that are commercially available from KLA Corp., Milpitas, Calif. Alternatively, the actual systems described herein may be designed “from scratch” to provide completely new actual systems.

If the virtual system is coupled to more than one actual system, the actual systems that generate output received and used by the virtual system in embodiments described herein may include different combinations of actual systems. For example, the actual systems may include at least one inspection tool and at least one other tool such as a defect review tool, a different inspection tool, an electrical tester, or a combination of two or more of a defect review tool, a different inspection tool, an electrical tester, etc. These embodiments may be configured as described further herein.

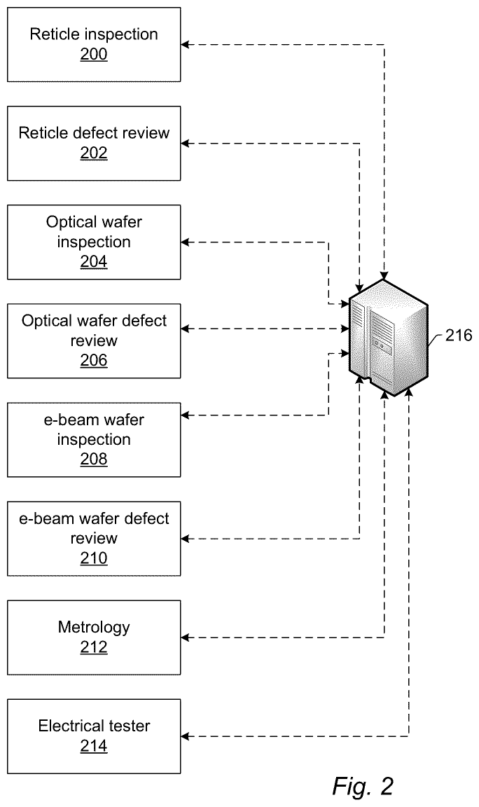

The actual system(s) may include reticle inspection tool 200 and/or reticle defect review tool 202, as shown in FIG. 2. The reticle inspection and defect review tools may be optical-based tool(s) and/or electron beam-based tool(s). Furthermore, the same actual system may be configured as both a reticle inspection tool and a reticle defect review tool. The reticle inspection and/or defect review tool may include any suitable commercially available systems. In addition, the reticle inspection and/or defect review tools may be configured to perform any kind of inspection and/or review. The reticle inspection and/or defect review tools may be configured to generate output, e.g., images or data, for the reticle in one or multiple imaging modes.

The actual system(s) may also or alternatively include at least one wafer inspection tool and/or a wafer defect review tool. The wafer inspection and wafer defect review tool(s) may be light-based tool(s). For example, as shown in FIG. 2, the actual systems may include optical wafer inspection system 204 and/or optical wafer defect review system 206. In addition, the same actual system may be configured as both a wafer inspection tool and a wafer defect review tool. The light-based wafer inspection and/or defect review tools may include any suitable commercially available systems such as the Puma systems, the 29xx and 39xx systems, and the SPx, Surfscan, and Surfimage systems that are commercially available from KLA. In addition, the light-based wafer inspection and/or defect review tools may be configured to perform any kind of inspection and/or review such as dark field (DF) laser scattering, narrow band bright field (BF), broadband BF, etc. The light-based wafer inspection and/or defect review tools may also include any suitable light source such as a broadband plasma (BBP)-based light source. The wafer inspection and/or defect review tools may be configured to generate output (e.g., images or data) for the wafer in one or multiple imaging modes.

The wafer inspection tool and/or wafer defect review tool may alternatively be configured as electron beam-based tool(s). For example, as shown in FIG. 2, the system may include e-beam wafer inspection tool 208 and/or e-beam wafer defect review tool 210. In addition, the same actual system may be configured as both a wafer inspection tool and a wafer defect review tool. The electron beam-based wafer inspection and/or defect review tool(s) may include any suitable commercially available systems such as the eDRxxxx systems that are commercially available from KLA.

The actual system(s) may include at least one metrology tool. For example, as shown in FIG. 2, the actual systems may include metrology tool 212. The metrology tool may include any suitable commercially available metrology tool. The metrology tool may be configured to measure or determine any one or more characteristics of any of the specimens described herein. For example, the metrology tool may be configured as a scatterometry system that is configured to measure or determine a critical dimension or critical dimension uniformity of patterned features on a wafer. Metrology tools are generally different than inspection tools in that the metrology tools do not scan over wafers or reticles generating output at each location that is scanned. Instead, metrology tools often perform measurements at one or a limited number of measurements spots on a wafer or reticle in a move-acquire-measure type scenario. In some instances, the metrology tool may perform measurements based on output or results of another actual system described herein. For example, the metrology tool may be used to measure one or more characteristics of defects detected by inspection. Control of the metrology tool in this manner may be further performed as described herein.

The actual system(s) may further include at least one electrical tester such as electrical tester 214, as shown in FIG. 2. The electrical tester may include any suitable commercially available electrical testing system. The electrical tester may be a contact type system in which one or more elements of the system make contact with one or more device structures formed on a specimen such as a wafer in order to establish an electrical connection between the wafer and the tester. Alternatively, the electrical tester may be a non-contact type system in which none of the elements makes contact with the wafer during the testing.

Although a variety of specific tools that may be the actual system(s) are described herein, the invention is not limited to these specific tools. For example, it is conceivable that any actual system configured to perform one or more processes on a wafer, reticle, or other specimen described herein may be included in the actual system(s). In one such example, the actual system(s) may also include failure analysis tools and/or materials analysis tools. In addition, the actual system(s) are not limited to light- and electron beam-based tools. For example, the actual system(s) may include ion beam-based tools such as commercially available focused ion beam (FIB) systems, helium ion microscopy (HIM) systems, and secondary ion mass spectroscopy (SIMS) systems.

As mentioned above, the system includes a virtual system coupled to an actual system to thereby receive output generated by the actual system. For example, as shown in FIG. 1, actual systems 100 and 102 are coupled to virtual system 116. In one embodiment, detectors 112 of the actual systems may be coupled to the virtual system so that output of the detectors may be sent directly to the virtual system. In this manner, the virtual system may receive raw output of the detectors (i.e., output that has not been altered by any data, signal, or other processing). In addition or alternatively, computer subsystems 114 of the actual systems may be coupled to the virtual system so that the computer subsystems can send output of the detectors and/or any other information generated by the computer subsystems to the virtual system. The virtual system may also be coupled to a computer subsystem, detector(s), and any other elements of an actual system. The virtual system may be coupled to any components of the actual systems as described further herein. For example, virtual system 116 may be coupled to computer subsystem(s) 114 as shown by the dashed lines in FIG. 1 by any suitable transmission media, which may include any suitable wired and/or wireless transmission media known in the art. Virtual system 216 may be coupled to any or all of the actual systems shown in FIG. 2 in any of the same manners.

As described above, the actual systems may include a variety of different actual systems in various combinations. Therefore, the output received from the actual systems may be different and vary depending on the configuration of the actual systems and/or the actual process(es) performed on the specimens by the actual systems. For example, the output may include mapping of spatially continuous data (such as may be generated by a scanning actual system), spatially discrete data (such as may be generated by a move-acquire-measure system), metrology data, point defect detection data, etc.

The virtual system includes at least a computer system and a storage medium. The term “computer system” is used interchangeably herein with the term “computer subsystem.” Each of the computer subsystem(s) or system(s) described herein may take various forms, including a personal computer system, image computer, mainframe computer system, workstation, network appliance, Internet appliance, or other device. In general, the term “computer system” may be broadly defined to encompass any device having one or more processors, which executes instructions from a memory medium. The computer subsystem(s) or system(s) may also include any suitable processor known in the art such as a parallel processor. In addition, the computer subsystem(s) or system(s) may include a computer platform with high speed processing and software, either as a standalone or a networked tool. The storage medium may include any suitable storage medium known in the art or described further herein.

Although the virtual systems are shown in the figures as having a particular computer configuration, it is to be understood that the virtual systems may have any suitable computer-like configuration. For example, the virtual system shown in FIG. 1 may be formed of only the processor, memory, and input/output components of the virtual system but not any components that can accept user input (e.g., keyboards, mice, screens, etc.). In this manner, the virtual system may not include all of the components that would normally make up a free-standing fully functional computer system. However, in other instances, the virtual system may resemble a fully functioning computer system in that a user can use the virtual system directly to perform one or more functions using any of the data stored therein. In addition, more than one workstation or user can access the virtual system simultaneously, remotely, and/or wirelessly. For example, as shown in FIG. 1, multiple workstations 118 and 120 can be coupled to the virtual system simultaneously. In this manner, multiple users may access the virtual system or data stored therein and use the virtual system to perform one or more of the functions described further herein.

The virtual system is not capable of having the physical version of the specimen disposed therein. For example, although the virtual system is configured to perform one or more functions for the specimen, the virtual system is not configured to perform the one or more functions on the specimen. Instead, the one or more functions for the specimen may be performed on data or other output produced by an actual process performed on the specimen by an actual system. Therefore, unlike the actual systems described herein, the virtual system may not have any specimen handling capabilities such as stages, motors coupled to stages, specimen handling devices or robots, or the like. In addition, although the virtual system may be configured to control one or more of the actual systems such that the actual system(s) perform process(es) on actual specimens, the virtual system cannot in of itself perform any actual processes on actual specimens. In one such embodiment, the virtual system may be configured as a virtual inspector (VI or VIVA). A VI can be generally defined as a computer system that can store massive amounts of output generated for a specimen by an inspection subsystem such that the output can be “played back” in a manner that mimics real time acquisition of the output during which a virtual inspection can be performed for the specimen using only the stored output.

The virtual system and the actual system may be further configured as described in U.S. Pat. No. 8,126,255 issued on Feb. 28, 2012 to Bhaskar et al., U.S. Pat. No. 9,222,895 issued on Dec. 29, 2015 to Duffy et al., U.S. Pat. No. 9,816,939 issued on Nov. 14, 2017 to Duffy et al., U.S. Pat. No. 9,916,965 issued on Mar. 13, 2018 to Bhaskar et al., U.S. Pat. No. 10,402,461 issued on Sep. 3, 2019 to Karsenti et al., U.S. Pat. No. 10,416,088 issued on Sep. 17, 2019 to Duffy et al., U.S. Pat. No. 10,539,612 issued on Jan. 21, 2020 to Duffy, and U.S. Pat. No. 10,551,827 issued on Feb. 4, 2020 to Duffy, which are incorporated by reference as if fully set forth herein.

The virtual system is configured for performing one or more functions for the specimen with two or more protected data sources from two or more different entities, respectively. In this manner, the embodiments described herein provide benefits for the control of semiconductor processes by resolving the “distrust barrier” by enabling “cooperation among adversaries.” For example, the VI concept has evolved over time from the initial concept of massive image capture and playback (inspector emulation). This evolution is represented by the patents incorporated by reference above. Nevertheless, practical realization of the applications enabled by the body of VI innovation can be greatly enhanced by data access, protected as described further herein in accordance with intellectual property (IP) protection policies among multiple companies that own the data sources required. Embodiments of the one or more functions that are performed by the virtual system with the two or more protected data sources are described further herein.

The term “entity” as used herein is defined as any entity that protects a data source, particularly a protected data source related to the semiconductor arts, from another entity. Therefore, the term “different entities” as used herein is defined as any entities that separately protect different data sources from each other. The entities may include individuals or groups of individuals, but more likely than not the different entities will be different corporations, companies, organizations, academic institutions, consortiums, joint ventures, etc. that generate and protect IP related in some way to the manufacture of semiconductor devices. In this manner, the entities may include any legally recognized entity that has a right to some IP that they are interested in protecting from another legally recognized entity. The different entities may also be “adversaries” such as stakeholders associated with different corporate entities that have fiduciary responsibilities to the stockholders of the respective entities.

The term “protected data source” as used herein is defined as any IP that a legally recognized entity has an interest in preventing from being disseminated publicly. The protected data sources described herein may include information classified by an entity as a trade secret, but that is not necessary for the purposes of the embodiments described herein. In other words, regardless of any protection that is or is not sought, legally or otherwise, by an entity, a data source may be considered “protected” for the purposes described herein if it is not meant to be disseminated outside the entity in an uncontrolled, or possibly even controlled, manner.

The term “data source” as used herein is defined as any information from any source that is stored in any manner. For example, a data source may be a computer-aided design (CAD) for a semiconductor device, but that design may be in any format and stored in any suitable data structure. Other examples of data sources that may be utilized in the embodiments described herein include other types of design data, real and/or simulated images of a specimen, test results for a specimen, information about the fabrication process used to produce some portion of a device on a specimen, and any other information sources particularly those related to the design, fabrication, and yield control of semiconductor devices.

Examples of characteristics of technical domains that are involved in solving critical problems in the semiconductor industry and may therefore generate protected data sources that may be used in or by the embodiments described herein further include, but are not limited to:
Design functions:
   Work products including but not limited to chips, masks, packages, subsystems
   Goals include translating from electrical intent to physical intent for manufacturing
   Done computationally
   Design IP ownership is typically separate from the manufacturing function ecosystem
   Insertion of sensors and test functionality (e.g., design for test (DFT)) into circuits to aid verification and diagnosis
   Tools are sources from an ecosystem of electronic design automation (EDA) and technology computer-aided design (TCAD) suppliers
Make functions:
   Reticles
      Designed for wafer manufacturing (e.g., patterns must be compatible with intended lithography and etch processes, which further depends on materials characteristics such as films and doping)
      Designed for reticle manufacturing (e.g., patterns need to be compatible with the exposure equipment and subsequent processing steps)
   Wafers, packages, and subsystems
      ecosystem of factories (fabs), equipment, software, and materials suppliers
      equipment suppliers can focus on one or more domains
         metrology and inspection equipment
         inline electrical test
         inline material and failure analysis
      control software (manufacturing execution systems (MES), advanced process control (APC), fault detection and classification (FDC), etc.)
      analytical software, all with independent IP protection stakes
Test functions: conformance to electrical intent at wafer, chip, package, subsystem steps
   Based on knowledge of the intended static and dynamic behavior of the chip under test
   Performed with equipment that physically handles the wafer/device under test
   Performed with complex programs Additional examples of protected data sources that may be provided to and used by the trusted virtual system in a secure manner include all of the following:
Test programs
Physical TCAD models (typically from a representative set of regions of a chip)
Electrical TCAD models (e.g., associated with the physical models mentioned above)
Metrology data
Physical failure analysis
Fully annotated netlists
Fully annotated place and route maps

The virtual system is configured for performing a virtual version of a process capable of being performed by the actual system for the physical version of the specimen. As described above, the virtual system may be configured as any type of virtual system such as a VI. The virtual version of the process that is performed by the virtual system may include any virtual process, which may vary depending on the configuration of the virtual system and the actual system coupled thereto. For example, if an actual inspection system is coupled to the virtual system, then the virtual process may be a virtual inspection process performed with output generated by the actual inspection system. If an actual metrology system is coupled to the virtual system, then the virtual process may be a virtual metrology process performed with output generated by the actual metrology system. Such virtual processes may be performed as described further herein, possibly in coordination with the one or more other functions performed by the virtual system. For example, results of one or more functions performed by the virtual system may be input to the virtual process. Results of one or more functions performed by the virtual system may determine some parameter of how the virtual process is performed. Results of the virtual process may be input to the one or more functions performed by the virtual system. Additional details of such embodiments are described further herein.

The virtual system described herein may, therefore, be configured as a trusted virtual system such as a VI with adversarial cooperation features. The trusted virtual systems described herein were created to enable powerful process control and diagnosis applications for the semiconductor industry including those described in U.S. Pat. No. 9,916,965 to Bhaskar et al. issued Mar. 13, 2018, which is incorporated by reference as if fully set forth herein, in a manner that can coexist with the high performance computing (HPC) style of virtual system software and computer infrastructure such as that described in U.S. Pat. No. 8,126,255 to Bhaskar et al. issued Feb. 28, 2012, which is incorporated by reference as if fully set forth herein The embodiments described herein enable the shift of risk calculus of decision makers in the direction of allowing the use of high value IP with multiple owners to be processed within the trusted virtual system. One reason why the embodiments described herein are particularly useful at this time is that as the process dimensions shrink, devices become more complex in the z direction (normal to the wafer surface) and resultant in-process observability of the state of a wafer, package, subsystem, etc. becomes less transparent. Therefore, the industry is becoming more and more dependent on the application of virtualization (often referred to as “digital twin”) methodology and artificial intelligence (AI), more precisely physics based AI techniques for inferring the state of work in progress (WIP).

In one embodiment, the virtual system is coupled to the actual system by a local network. The local network may be configured so that the virtual system is connected to the actual system by some hardware elements, like wired transmission media, configured for transmitting information, images, instructions, output, etc. between the two systems. In general, however, any suitable local network configuration may be used in the embodiments described herein. The networking of the embodiments described herein may also benefit from an infrastructure compute platform and/or secure networking hardware like the NVIDIA BlueField-3 data processing unit (DPU) and/or Mellanox Firmware Tools (MFT), which are commercially available from NVIDIA Corp., Santa Clara, Calif.

One reason why a virtual system coupled to an actual system by a local network makes sense for the embodiments described herein is the sheer size of the image data that may have to be handled by the virtual system for some of the functions described herein. For example, it may not be practical, or even possible, to perform some of the functions described herein on a cloud or hybrid cloud type system because networks generally are not fast enough. The new data sources and applications described herein that are to be used or performed, possibly in concert with the massive image data from the actual system, are arguably also parts of the virtual system regardless of where the computation is done. The determining factor may be the (near) real time interaction between the various aspects of the embodiments described herein. For example, AI techniques naturally enable data driven learning and/or improvements of models for defect detection thereby making their use on hardware like the virtual systems described herein, which is actually connected to the massive image generation and/or storage, advantageous. There is also a benefit in learning loops (e.g., updating training data with simulation results for detection deep learning (DL) networks that can then be immediately used for improved inference on a stored wafer image) that is provided by performing such simulations on a virtual system such as that described herein. Therefore, what constitutes a virtual system configured as described herein may be somewhat blurry in the cloud computing era. The benefit of close proximity between the virtual system and the actual system on a local network is that the functions described herein are in general “data heavy” operations (high network cost) and “compute heavy” so it makes sense to utilize the computers for multiple functions. In other words, the virtual system may function as a local cloud. But the reason that the virtual system would not be “in the cloud” is because the functions described herein produce and use such massive amounts of image data.

Even if the functions and data sources described herein make connecting the virtual and actual systems by a local network most practical, certain functions described herein may be performed or configured in a cloud-based manner. For example, the embodiments described herein may utilize state of the art cloud cyber-security features enabled by products such as the Azure cloud platform commercially available from Microsoft Corp., Redmond, WA, and AWS Cloud Security commercially available from Amazon Web Services (AWS), Seattle, WA. In addition, the embodiments described herein may utilize cloud collaboration features of products such as the Azure cloud platform and software commercially available from AWS and Synopsys, Inc., Mountain View, Calif. such as the Static Application Security Testing (SAST) products. The embodiments described herein may also make use of secure computing systems hardware and/or software like that commercially available from defense contractors and consultants such as IBM Research, Yorktown Heights, NY.

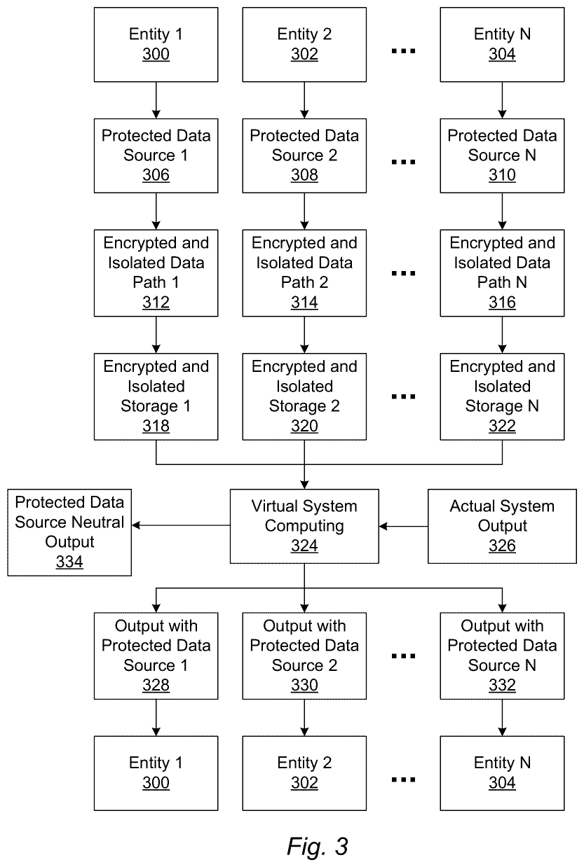

In some embodiments, the virtual system is configured for receiving the two or more protected data sources on two or more encrypted and isolated data paths, respectively, and for storing the two or more protected data sources on two or more encrypted and isolated portions, respectively, of the storage medium. In this manner, the embodiments described herein may be configured for isolation of data paths (for storage and networking). For example, FIG. 3 shows one embodiment of a trusted virtual system, which may be a trusted VI. As shown in FIG. 3, entity 1 (300), entity 2 (302), . . . , and entity N (304) may separately protect protected data source 1 (306), protected data source 2 (308), . . . , and protected data source N (310), respectively, from each other.

Although FIG. 3 shows three or more different entities, the number of different entities that provide protected data source(s) to the virtual system is not limited in any practical sense. In addition, although FIG. 3 shows that each different entity provides one protected data source to the virtual system, each different entity may send any number of protected data sources to the virtual system.

The different entities may input their respective protected data sources to the virtual system at the same time or at different times. For example, one function performed for a specimen by the virtual system may be performed with two different protected data sources from two different entities, and the function may be performed after both protected data sources have been received, whether that is at different times or the same time.

Each of the entities may input or enable input of their respective protected data sources into different isolated data paths of the trusted virtual system. For example, protected data source 1 may be input to encrypted and isolated data path 1 (312), protected data source 2 may be input to encrypted and isolated data path 2 (314), . . . , and protected data source N may be input to encrypted and isolated data path N (316). The data paths may be encrypted and isolated in any suitable manner known in the art.

The virtual system may then store each of the protected data sources in a respective encrypted and isolated portion of the storage medium of the virtual system. For example, protected data source 1 received via encrypted and isolated data path 1 may be stored in encrypted and isolated storage 1 (318), protected data source 2 received via encrypted and isolated data path 2 may be stored in encrypted and isolated storage 2 (320), . . . , and protected data source N received via encrypted and isolated data path N may be stored in encrypted and isolated storage N (322). The storage medium portions may be encrypted and isolated in any suitable manner known in the art. For example, the security of the storage medium of the virtual system and any protected data sources stored therein may be ensured using a commercially available product like the Multi-Level Security (MLS) Solution for Lustre that can be used to provide user and data isolation, which is available from DDN, Chatsworth, Calif. or another similarly configured product.

Any of the protected data sources stored in any of the encrypted and isolated storage portions may be input to virtual system computing 324 alone or in any combination thereof. Virtual system computing 324 may include performing any one or more of the functions described herein, which may be performed using any one or more of the protected data sources, possibly in combination with actual system output 326, which may be any results or output generated by the actual system for a physical version of the specimen. For example, actual system output 326 may include output from an actual inspection system.

The primary IP protection that may currently occur on a VI is encryption of the mass image data. Any protected data source that is fed into the virtual systems described herein may be the same as data that is already allowed on the actual tools being emulated by the VI. The data sources required for optimum process control solutions (AI based or not) almost always cross one or more IP protection boundaries. To the extent that protected data is shared, possible mechanisms for protection include, but are not limited to:
Reputation and credibility earned over time by a company or individuals
Encryption, as in the case of the mass image data sored on a VI
Legal agreements including but not limited to non-disclosure agreements
Information compartmentalization within and between participating companies
Simply preventing the disclosure of information

In another embodiment, the virtual system is configured for performing the one or more functions using homomorphic encryption. For example, virtual system computing 324 may include homomorphic computing or homomorphic HPC. Other forms of encrypted computing may also be used in the embodiments described herein. Homomorphic encryption is usually defined in the art as a type of encryption that allows computations to be performed on encrypted data without any decryption. The resulting computations are performed in an encrypted form which can then be decrypted to produce an output that would be the same as if the computations had been performed on the unencrypted data. Homomorphic encryption then can be used for allowing parties, not privileged to the data, to process the data while it remains encrypted. Therefore, homomorphic encryption is particularly suitable for the embodiments described herein. For example, homomorphic encryption may be used by an inspection tool operator to setup an inspection process based on encrypted design data from a fabless customer without having to decrypt the design data. While homomorphic encrypted computing is particularly advantageous for the embodiments described herein, any other commercially available technology that allows performing a function based on one or more encrypted data sources without any decryption of the data source(s) may be used in the same manner for performing the functions described herein.

Nominally, while the inputs to the trusted virtual system may include highly guarded secret information, the output of the application software programs integrated with the system in general may pose a much lower threat to the stakeholders as they are expected to often closely resemble currently used tool outputs. For example, an inspection recipe generated by the virtual system using a protected data source from a first entity such as a semiconductor device designer may typically be provided to a second entity such as an inspection tool operator without any threat to data security because the protected data source would not normally be included in, or discernable from, the inspection recipe. Nonetheless, the trusted virtual system can accommodate IP protection on the inputs as well as the outputs.

In one embodiment, the virtual system is configured for generating output of the one or more functions and providing the output to a first of the two or more different entities without exposing any of the two or more protected data sources not from the first of the two or more different entities. For example, virtual system computing 324 may generate a number of different outputs, which may vary depending on the function(s) performed by the virtual system using the received protected data sources. As shown in FIG. 3, virtual system computing 324 may produce protected data source neutral output 334, output with protected data source 1 (328), output with protected data source 2 (330), . . . , and output with protected data source N (332). Each of these outputs may have been generated by a single function performed by the virtual system, or one or more of the outputs may be generated by different functions performed by the virtual system. If the virtual system performs one function with one protected data source and another separate function with a different protected data source, then generating output that ensures the security of the protected data sources should be relatively straightforward, particularly if the output generated by any one function goes solely to the entity that provided the protected data source used for that function.

Protecting the data sources in the virtual system outputs can become more complex when two different protected data sources from two different entities are used in combination for a single function and/or when the results of a function performed with a protected data source from a first entity are to be sent to a second entity without compromising the protected data source from the first entity. One way to do that is to ensure that any output generated by the virtual system contains only the protected data source(s) from the entity receiving the output. In this manner, the output(s) generated by the virtual system for any one function performed by the virtual system may include one or a combination of the outputs shown in FIG. 3 depending on which entity is receiving the output and which protected data sources were used. In any case, the virtual system may produce separate outputs from a single function (or more than one function) that contain only the protected data source of the entity receiving the output. In particular, as shown in FIG. 3, output with protected data source 1 may only be sent to entity 1, output with protected data source 2 may only be sent to entity 2, . . . , and output with protected data source N may only be sent to entity N.

One reason that a virtual system may generate a protected data source neutral output is if an entity that does not own any of the protected data source(s) used to perform a function for a specimen is to receive the output of that function. For example, the virtual system may perform a single function using protected data sources 1, 2, . . . , and N, and entity N+1 (not shown) may be a recipient of that output. Therefore, the output that is generated and sent to entity N+1 should not include the protected data sources of any of entities 1, 2, . . . , and N.

In any case, the virtual system, regardless of the function(s) performed and the protected data source(s) used for the function(s), is preferably configured to generate output in a manner that does not violate current customer/supplier norms in terms of the contract of what is legitimately customer owned data from a supplier tool.

In some embodiments, the virtual system is configured for securely disposing of the two or more protected data sources after performing the one or more functions. For example, the virtual system is preferably configured for making exportation of the proprietary data impossible and may be configured for destroying the data in an irretrievable way after its use is complete. In this manner, the entities who provide their protected data sources to the virtual system can be assured that their data will not linger in the system thereby mitigating the risk of accidental exposure or transmission. The virtual system may be configured for making a protected data source irretrievable in any suitable manner known in the art.

In a further embodiment, the virtual system is configured for restricting control of hardware encryption keys for the two or more protected data sources to only the two or more different entities, respectively. For example, the embodiments described herein may be configured for stakeholder control of hardware encryption keys (e.g., for storage, networking, and computing). The hardware encryption keys may be configured in any suitable manner known in the art, and the embodiments described herein may be configured to restrict control of those keys in any suitable manner.

In another embodiment, the virtual system is configured for third party verification of safety of the two or more protected data sources within at least the computer system and the storage medium of the virtual system. For example, the embodiments described herein may be configured for “safe by design” hardware and software topology with trusted third-party verifiability. Third-party verifiability may be enabled using any suitable commercially available software and/or hardware known in the art.

In an additional embodiment, the virtual system is configured for enforcing safety of the storage medium via the Rust programming language. For example, the embodiments described herein may be configured to use memory safe software (e.g., using the Rust software language).

In one embodiment, performing the one or more functions includes performing a first of the one or more functions using at least two of the two or more protected data sources. In this manner, one of the functions may be performed using some combination of two or more protected data sources. The function may be performed with all of the two or more protected data sources stored in or available to the virtual system. However, a single function may be performed with fewer than all of the two or more protected data sources stored in or available to the virtual system.

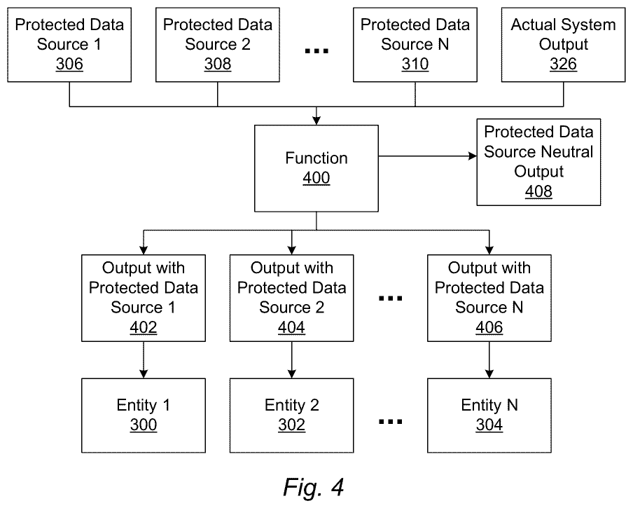

One such embodiment is shown in FIG. 4. In this embodiment, the virtual system may receive protected data source 1 (306), protected data source 2 (308), . . . , and protected data source N (310) from entities 1, 2, . . . , and N, respectively, which are shown in FIG. 3. The virtual system may then perform function 400 using at least two of the protected data sources, e.g., protected data source 1 and N or protected data sources 1, 2, . . . , and N. In some embodiments, the input to the function may also include actual system output 326, which may include any output generated by any of the actual systems described herein, including but not limited to inspection system images, metrology measurements, and the like. Function 400 may include any of the functions described herein. For example, a function like simulating performance of an inspection system may require two or more protected data sources such as a semiconductor device design, a 3D specimen model, and an inspection system model, each of which may be from different entities. Nevertheless, the embodiments described herein have been designed to ensure the safety and security of such protected data sources throughout the entire process. Output generated by performing function 400 may include output with protected data source 1 (402), output with protected data source 2 (404), . . . , and output with protected data source N (406), which may be generated and configured as described further herein. In addition, as shown in FIG. 4, output with protected data source 1 may only be sent to entity 1, output with protected data source 2 may only be sent to entity 2, . . . , and output with protected data source N may only be sent to entity N. In this manner, the entities will not receive output that exposes any of the protected data sources from other entities. As further shown in FIG. 4, function 400 may produce protected data source neutral output 408, which may be generated as described further herein. In this manner, the output of function 400 may be provided to an entity that does not have permission to receive any of the protected data sources that were input to function 400.

In another embodiment, performing the one or more functions includes performing a first of the one or more functions using only a first of the two or more protected data sources and performing a second of the one or more functions using only a second of the two or more protected data sources. In this manner, different functions may be performed with different protected data sources, respectively. For example, a first function may be performed with a first protected data source, a second function may be performed with a second protected data source, and so on.

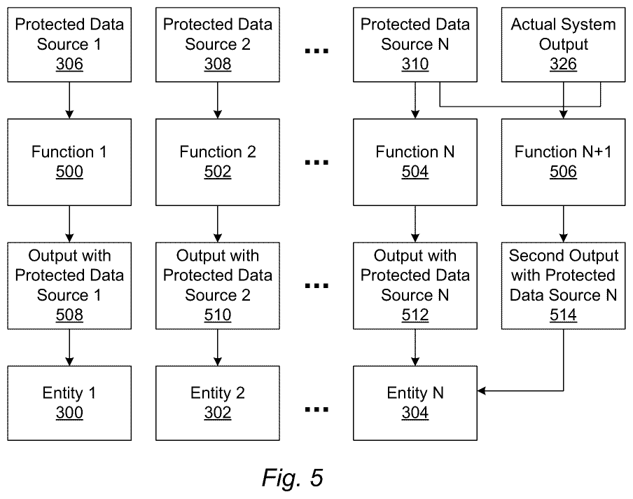

One such embodiment is shown in FIG. 5. In this embodiment, the virtual system may receive protected data source 1 (306), protected data source 2 (308), . . . , and protected data source N (310) from entities 1, 2, . . . , and N, respectively, which are shown in FIG. 3. The virtual system may then perform function 1 (500) using only protected data source 1, function 2 (502) using only protected data source 2, . . . , and function N (504) using only protected data source N. In some embodiments, the input to one or more of the functions performed by the virtual system may also include actual system output 326, which may include any output generated by any of the actual systems described herein, including but not limited to inspection system images, metrology measurements, and the like. Function N+1 (506) may be performed using only protected data source N in combination with actual system output 326. In this manner, although different functions may be performed with different protected data sources, respectively, the inputs to any of the functions may include any other information described herein. Functions 500, 502, 504, and 506 may include any of the functions described herein.

Even if a function is being performed by the virtual system with only one protected data source from one entity, other protected data sources from other entities may be received by, stored on, and/or used by the virtual system while that function is being performed. In other words, regardless of which protected data source(s) is/are used for any function being performed at any time, any other protected data sources may simultaneously be received by, stored on, and/or processed by the virtual system in other functions, which may or may not be performed at the same time. In any such situations, the embodiments described herein have been designed to ensure the safety and security of such protected data sources throughout the entire process.

Output generated by performing function 500 may include output with protected data source 1 (508), output generated by performing function 502 may include output with protected data source 2 (510), . . . , output generated by performing function N may include output with protected data source N (512), and output generated by performing function N+1 may include second output with protected data source N (514), which may be generated and configured as described further herein. In addition, as shown in FIG. 5, output with protected data source 1 may only be sent to entity 1, output with protected data source 2 may only be sent to entity 2, . . . , and output and second output with protected data source N may only be sent to entity N. In this manner, the entities will not receive output that exposes any of the protected data sources from other entities. Although not shown in FIG. 5, any of functions 500, 502, 504, and 506 may produce a protected data source neutral output, which may be generated as described further herein. In this manner, the output of any one of the functions may be provided to an entity that does not have permission to receive the protected data source that was input to that function.

In addition or alternatively, a first function may be performed with a first combination of the protected data sources, a second function may be performed with a second combination of the protected data sources, and so on, and each of the protected data sources included in each of the combinations may or may not be mutually exclusive. In other words, one protected data source may not be included in more than one combination and therefore may not be used for more than one function. However, one protected data source may be included in two or more combinations and therefore may be used for more than one function. In this manner, not all of the protected data sources stored in or available to the virtual system may be used for any one function performed by the virtual system.

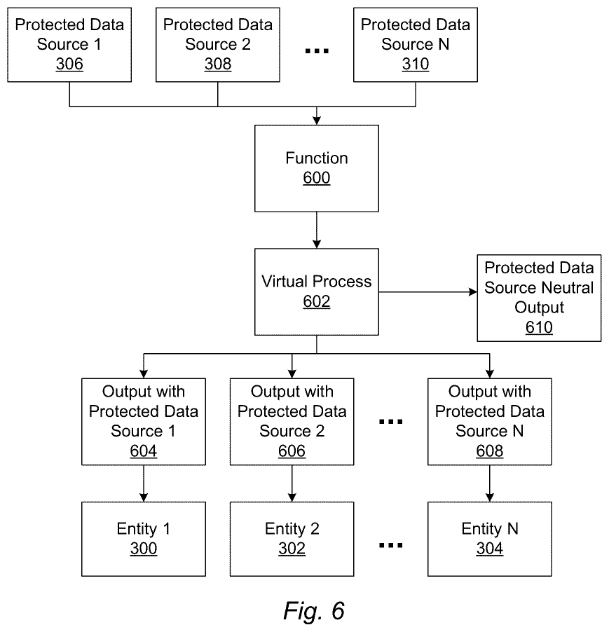

In a further embodiment, the virtual system is configured for performing the virtual version of the process using output of at least one of the one or more functions. One such embodiment is shown in FIG. 6. In this embodiment, the virtual system may receive protected data source 1 (306), protected data source 2 (308), . . . , and protected data source N (310) from entities 1, 2, . . . , and N, respectively, which are shown in FIG. 3. The virtual system may then perform function 600 using at least two of the protected data sources. Function 600 may include any of the functions described herein.

Output generated by performing function 600 may be input to virtual process 602. Virtual process 602 may be a virtual version of a process capable of being performed by the actual system for the physical version of the specimen. For example, the virtual process may be a virtual inspection process, a virtual metrology process, a virtual electrical testing process, and the like. In one such example, the output of function 600 may be an inspection process recipe selected for a specimen based on the simulated performance of an inspection system, and both the inspection process recipe selection and inspection system performance simulation may be performed in function 600 and as described further herein. Virtual process 602 may then include a virtual inspection process performed by applying the selected inspection process recipe to images of the physical version of the specimen generated by an actual inspection tool and stored in the virtual system.

Output generated by performing virtual process 602 may include one or more of output with protected data source 1 (604), output with protected data source 2 (606), . . . , and output with protected data source N (608), which may be generated and configured as described further herein. In addition, as shown in FIG. 6, output with protected data source 1 may only be sent to entity 1, output with protected data source 2 may only be sent to entity 2, . . . , and output with protected data source N may only be sent to entity N. In this manner, the entities will not receive output that exposes any of the protected data sources from other entities. As further shown in FIG. 6, virtual process 602 may produce protected data source neutral output 610, which may be generated as described further herein. In this manner, the output of virtual process 602 may be provided to an entity that does not have permission to receive any of the protected data sources that were input to function 600 and/or virtual process 602.

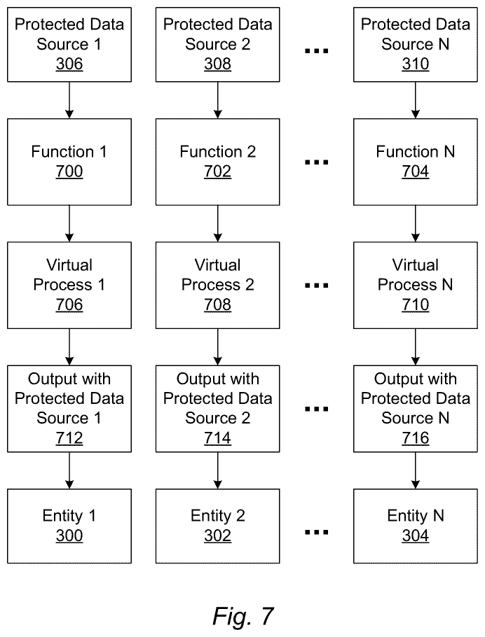

Another such embodiment is shown in FIG. 7. In this embodiment, the virtual system may receive protected data source 1 (306), protected data source 2 (308), . . . , and protected data source N (310) from entities 1, 2, . . . , and N, respectively, which are shown in FIG. 3. The virtual system may then perform function 1 (700) using only protected data source 1, function 2 (702) using only protected data source 2, . . . , and function N (704) using only protected data source N. Functions 700, 702, and 704 may include any of the functions described herein. In some embodiments, the input to one or more of the functions performed by the virtual system may also include actual system output (not shown in FIG. 7), which may include any output generated by any of the actual systems described herein, including but not limited to inspection system images, metrology measurements, and the like. Function N+1 (not shown in FIG. 7) may be performed using only one of the protected data sources in combination with the actual system output.

In this manner, although different functions may be performed with different protected data sources, the inputs to any of the functions may include any other information described herein. In addition, even if a function is being performed by the virtual system with only one protected data source from one entity, other protected data sources from other entities may be received by, stored on, and/or used by the virtual system while that function is being performed. In other words, regardless of which protected data source(s) is/are used for any function being performed at any time, any other protected data sources may be received by, stored on, and/or processed by the virtual system in other functions, which may or may not be performed at the same time. In any such situations, the embodiments described herein have been designed to ensure the safety and security of such protected data sources throughout the entire process.

Output generated by performing function 700 may be input to virtual process 1 (706), output generated by performing function 702 may be input to virtual process 2 (708), . . . , and output generated by performing function 704 may be input to virtual process N (710). Each of virtual processes 706, 708, and 710 may be any of the virtual processes described herein. In addition, each of virtual processes 706, 708, and 710 may be the same virtual process, e.g., the same virtual inspection process. Alternatively, one or more of virtual processes 706, 708, and 710 may be different virtual processes. For example, virtual processes 706 and 708 may be different virtual inspection processes, or virtual process 706 may be a virtual inspection process, virtual process 708 may be a virtual metrology process, and virtual process 710 may be a virtual defect review process.

Output generated by performing virtual process 706 may include output with protected data source 1 (712), output generated by performing virtual process 708 may include output with protected data source 2 (714), . . . , and output generated by performing virtual process 710 may include output with protected data source N (716), which may be generated and configured as described further herein. In addition, as shown in FIG. 7, output with protected data source 1 may only be sent to entity 1, output with protected data source 2 may only be sent to entity 2, . . . , and output with protected data source N may only be sent to entity N. In this manner, the entities will not receive output that exposes any of the protected data sources from other entities. Although not shown in FIG. 7, any of virtual processes 706, 708, and 710 may produce a protected data source neutral output (not shown), which may be generated as described further herein. In this manner, the output of any one of the functions may be provided to an entity that does not have permission to receive the protected data source that was input to that function.

In some embodiments, performing the one or more functions includes performing a first of the one of more functions for the specimen with at least one of the two or more protected data sources in combination with results generated by performing the virtual version of the process. For example, any of the functions described herein may be performed with inputs that include a protected data source with any other information described further herein including results generated by performing a virtual inspection process, a virtual metrology process, a virtual electrical testing process, a virtual defect review process, etc. One example of a function that may be performed with a protected data source and results of a virtual process is simulating the electrical characteristics of a specimen by inputting results of a virtual inspection process into an electrical model that is a protected data source. Of course, this is just one of many possible functions that can be performed by the embodiments described herein using such inputs. What is important to note is that the embodiments described herein make possible the safe and secure use of a protected data source with any other data source, protected or not, to perform one or more semiconductor-related functions. By reducing the barriers to the use of protected data sources, the embodiments described herein provide many advantages to the entire semiconductor manufacturing ecosystem, some examples of which are described further herein.

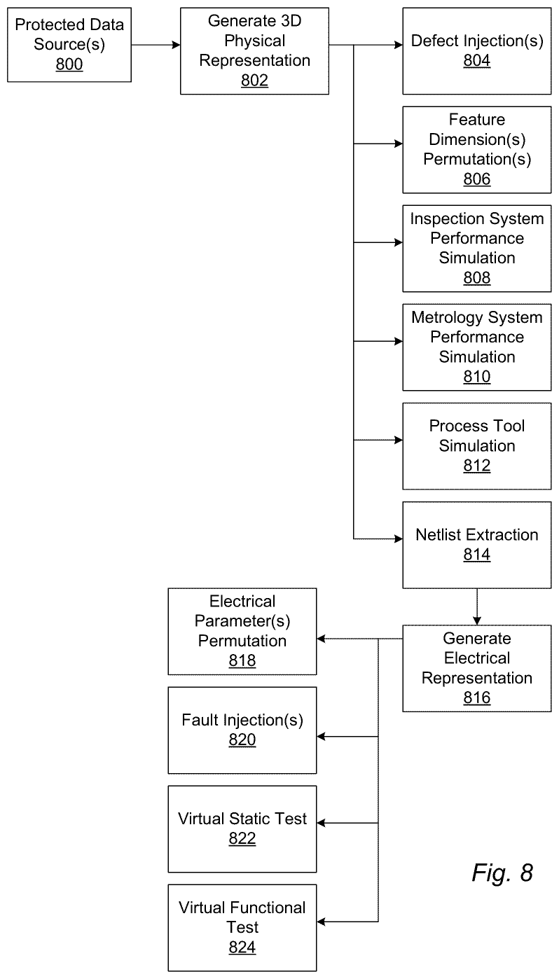

In one embodiment, the one or more functions include generating a three-dimensional (3D) physical representation of the physical version of the specimen. For example, as shown in FIG. 8, the virtual system may generate a 3D physical representation of a specimen in step 802 using protected data source(s) 800, which may include any of the protected data sources described herein such as semiconductor device design information and/or a 3D model. The 3D physical representation of the physical version of the specimen is not a simulation of how the specimen will look to any one tool or system such as a metrology tool or system. Instead, the 3D physical representation is a simulation of how the specimen looks in specimen space (e.g., if a perfect 3D image of the specimen could be formed in an exactly accurate way, which is obviously not possible given the practical physical limitations of actual imaging systems).

Generating a 3D physical representation of the physical version of the specimen may be performed using any models known in the art. One example of an empirically trained process model that may be used to generate a 3D physical representation of the physical version of the specimen includes SEMulator 3D, which is commercially available from Coventor, Inc., Cary, NC. An example of a rigorous lithography simulation model is Prolith, which is commercially available from KLA, and which can be used in concert with the SEMulator 3D product. However, the 3D physical representation may be generated using any suitable model(s) of any of the process(es) involved in producing actual specimens from the design data.

One of the advantages of the embodiments described herein is that the 3D physical representation of the specimen can be generated by the virtual system with a model that is a protected data source, e.g., a proprietary model, without exposing the protected data source. For example, as described further herein, the virtual system may receive a model of a fabrication process that is a protected data source from a first entity and input to the model a semiconductor device design that is a protected data source from a second entity to thereby generate a 3D physical representation of the physical version of the specimen having the semiconductor device design formed thereon. As described further herein, each step of data handling/processing from reception and storage to computing and output may be performed in such a manner that the protected data source of one entity is not shared with a different entity. In the example described above, the generated 3D physical representation may be provided to the semiconductor device designer, the fabrication process model developer, and/or another entity in different manners and containing different information so that the fabrication process model developer does not receive the semiconductor device design and vice versa. In addition or alternatively, the 3D physical representation may be output in such a way that it can be used by an inspection tool operator to generate an inspection process for the physical version of the specimen without having to access or use the semiconductor device design and/or the fabrication process model. The same is true for other types of tools such as metrology tools, defect review tools, etc.

In one such embodiment, the 3D physical representation is a specimen scale, 3D, TCAD, physical representation of the physical version of the specimen. For example, one application that is enabled by the trusted virtual system described herein is generating a wafer scale 3D, TCAD, physical representation of a physical wafer. TCAD is generally defined in the art as the use of computer simulations to develop and optimize semiconductor process technologies and devices. Generating such a 3D physical representation of the specimen may be performed using 3D technology modeling with TCAD software commercially available from Synopsys, Mountain View, Calif, and Silvaco, Santa Clara, Calif. While one of the advantages of the embodiments described herein over other systems and methods is that due to the virtual system configuration they make specimen scale 3D physical representation generation possible (as opposed to only being able to simulate a substantially small portion of the specimen), the embodiments described herein may be used to generate a 3D physical representation of any pre-selected portion of the specimen (e.g., only a portion of the semiconductor device being fabricated on the specimen).

In addition to generating a 3D physical representation of a specimen on a specimen scale (i.e., for a whole specimen), other functions described herein can be performed on the specimen scale. The specimen scale nature of the functions may be enabled by the specimen scale nature of the 3D physical representation (e.g., when it is used as an input to another function). However, the embodiments described herein are capable of performing functions on the specimen scale regardless of the input. For example, the virtual system may be configured to perform a virtual inspection of a specimen on a specimen scale using specimen scale images generated by an actual inspection system. In this manner, the embodiments described herein provide a virtual system that enables closed loop, digital twin experimentation at specimen scale.

In another embodiment, the one or more functions include injecting a defect into the 3D physical representation, as shown in step 804 of FIG. 8. For example, another application that is enabled by the trusted virtual system described herein is defect injection into the 3D TCAD physical representation described above. Defect injection may be performed as described in U.S. Pat. No. 10,599,951 issued Mar. 24, 2020 to Bhaskar et al., which is incorporated by reference as if fully set forth herein. Injecting a defect into the 3D physical representation may be performed by altering the design data that is input to step 802, and altering the design data to inject a defect may be performed as described in the above-referenced patent. In addition or alternatively, injecting a defect into the 3D physical representation may be performed by altering the 3D physical representation itself in the same manner that images are altered in the above-referenced patent to inject defects. The types and characteristics of the defects that are injected into the 3D physical representation may be determined in any manner, e.g., based on knowledge about the types of defects expected or known to be formed in certain devices having certain characteristics and/or by certain processes having certain process characteristics. Information for the injected defects may be acquired from a number of sources including, but not limited to, a semiconductor device designer and a semiconductor manufacturer.

The defect injection function is one of the primary motivations for the embodiments described herein. For example, the creation and use of DL based inspection (defect and classification) models is an area of significant interest for inspection tool customers and manufacturers. These models require hundreds of examples of defects to get the model trained and running (as in bootstrapping) before they can detect defects on real specimens. Today, finding a real example of a single defect scenario on a single geometry can take weeks. The goal then is to provide such an example 1000× faster. Part of the way that can be done is to artificially inject a synthetic defect into a 3D model of the specimen that an inspection tool customer may already have. Until now, inspection tool customers have typically been unwilling to share 3D models of specimens with inspection tool manufacturers or operators, and such information is unavailable to create synthetic defects for DL model training or bootstrapping. However, using the embodiments described herein which are configured for ensuring the safety of protected data sources in all aspects from reception, storage, usage and even output, an entity can safely and securely make a 3D physical representation of a specimen available to inspection tool setup functions thereby enabling better DL inspection and/or classification models to be generated for inspection. Creating better inspection recipes will obviously enable better inspection results, which is advantageous for everyone involved in making and using the end-result semiconductor device.

In an additional embodiment, the one or more functions include permutating dimensions of one or more features in the 3D physical representation, as shown in step 806 of FIG. 8. For example, an additional application that is enabled by the trusted virtual system described herein is permutation of the dimension(s) in the form of a design of experiments (DOE). In one such example, the dimensions that are permutated may be any dimensions of any features of the semiconductor device and/or specimen that are of interest to semiconductor designers and/or manufacturers including those that are typically measured in metrology processes. Such dimensions include, but are not limited to, line widths, contact hole diameters, alignment or spacing between features on one or more layers of the specimen, and film thicknesses. The degree to which any of the features are permutated in their dimensions may vary depending on a number of factors including the semiconductor design itself and the process used to fabricate it on a specimen. In this manner, the permutation of the dimensions may be performed based on input from the semiconductor device designer and/or the semiconductor manufacturer, which may be provided to the virtual system as one or more protected data sources. Those protected data sources may then be handled in a secure and safe fashion as described further herein.

Permutating the dimensions of one or more features in the 3D physical representation may be useful for a number of applications such as examining how the variations affect the inspection of the specimen and how they can manifest as defects. For example, AI techniques like DL networks enable the inclusion of potential sources of variation that may not have an obvious cause and effect at first glance. Much of the work in inspection is to identify aspects of the fabrication process that need to be measured and controlled better in order to eliminate the sources of the defect mechanisms. Systematic defect sources typically have multiple dependencies on physical parameters that need to be controlled better. Part of the value for the “digital twin” functionality provided by the virtual system is to predict multi-variate process marginalities and in turn predict what these would look like to an inspector. Similar in concept to “Bayesian priors,” the power of this function is that it enables proactively looking for signatures in optical (or other inspector) data that would otherwise be ignored. In this manner, the 3D physical representation(s) of a specimen with permutated feature dimensions may be input to the simulating function(s) described further herein.

In a further embodiment, the one or more functions include simulating performance of an inspection system based on the 3D physical representation, as shown in step 808 of FIG. 8. For example, a further application that is enabled by the trusted virtual system described herein is defect inspection tool simulation that takes the 3D physical model as input. Therefore, such a simulating step may use, as input, protected data source(s) of an inspection system manufacturer. For example, information about the inspection system such as an optical transfer function may be used as input to a simulation of the inspection system performance.

Simulating performance of an inspection system may also be performed using a model of the imaging performed by the inspection system. In other words, the performance may be simulated using a physics-based or forward simulation model of the inspection system. Simulating the performance of the inspection system may also include simulating images that may be produced by the inspection system using a model such as WINsim, which is commercially available from KLA, and which can rigorously model the response of an inspector using an electromagnetic (EM) wave solver. Such simulations may be performed using any other suitable software, algorithm(s), method(s), or system(s) known in the art.

Simulating the performance of the inspection system may however also or alternatively be performed in a generative manner using a DL type model or network. For example, simulating the performance of the inspection system may include simulating images that may be produced by the inspection system with a generative adversarial network (GAN) or a variational Bayesian method. In one such example, a GAN or variational Bayes method may be used to create realistic looking images that simulate the performance of an inspection system. The GAN or variational Bayesian method may be performed as described in U.S. Pat. No. 10,599,951 issued Mar. 24, 2020 to Bhaskar et al., which is incorporated by reference as if fully set forth herein. The embodiments described herein may be further configured as described in this patent.

The embodiments described herein may also be configured to setup and/or perform an inspection process as described in U.S. Patent Application Publication Nos. 2009/0080759 to Bhaskar et al. published Mar. 26, 2009 and 2014/0241610 to Duffy et al. published Aug. 28, 2014 and U.S. Pat. No. 7,676,077 to Kulkarni et al. issued on Mar. 9, 2010, U.S. Pat. No. 7,877,722 to Duffy et al. issued on Jan. 25, 2011, U.S. Pat. No. 8,194,968 to Park et al. issued on Jun. 5, 2012, U.S. Pat. No. 8,611,639 to Kulkarni et al. issued on Dec. 17, 2013, and U.S. Pat. No. 9,183,624 to Karsenti et al. issued on Nov. 10, 2015, which is incorporated by reference as if fully set forth herein. The embodiments described herein may be further configured as described in these publications and patents.

Simulating performance of an inspection system based on the 3D physical representation is another practical example of how the embodiments described herein provide important improvements and advantages over currently used systems. For example, today, inspection tool manufacturers, owners, operators, etc. do not get the 3D physical model of a specimen to be inspected as input to inspector simulations. An engineer might guess, with the aid of some select inputs from the semiconductor device design owner, which can take weeks or even months and can be iterative. The embodiments described herein, however, provide systems and methods that ensure the security of the protected data sources of semiconductor device designers such as the 3D physical model, which can then be modified for simulations thereby eliminating the current “wasted” work of the inspection tool manufacturers, owners, operators, etc. of making incorrect versions of the models.

In some cases simulating the performance of the inspection system may include only simulating the imaging portion of an inspection process, i.e., simulating what images of the specimen generated by an inspection system would look like under one or more sets of imaging hardware parameters. Such simulations can enable a kind of Bayesian inspector concept. For example, given some metrology data for a specimen, the virtual system can infer what the expected 3D TCAD representation of the specimen will be. The 3D TCAD representation can then be used to generate a simulation of the expected inspector image. In some instances, the expected inspector image can be used as a reference to compare to the actual acquired and/or stored image of the wafer from an inspector, virtual or actual. Such an expected inspector image may therefore be used as a reference image, and this type of image comparison may be performed for die-to-database type defect inspection.

The simulated inspector image may also or alternatively be used to setup one or more parameters of the inspection process. For example, simulated images generated for different modes of the actual inspection tool (defined by one or more different imaging parameters of the system, other than location on the specimen at which the images are generated) may be produced by the virtual system based on the 3D TCAD representation of the specimen and used to determine which mode is best for inspection of the specimen performed by the actual system. Such simulations may also be performed for different actual systems to determine which tool is best for specimen inspection. The simulated images may also be used to select one or more parameters of a defect detection method that is used to detect defects in the images. Such parameters of the defect detection method may include, but are not limited to, which defect detection algorithm is used for inspection, which parameters such as threshold are used for inspection, and the like. In this manner, all aspects of an actual inspection process performed by an actual inspection system may be setup based on the simulated inspector images generated from the 3D TCAD representation.

In some embodiments, the one or more functions include simulating performance of a metrology system based on the 3D physical representation, as shown in step 810 of FIG. 8. For example, another application that is enabled by the trusted virtual system described herein is metrology tool simulation that takes the 3D physical model as input. Examples of how the virtual system may simulate performance of a metrology system are described in U.S. Pat. No. 10,496,781 to Fang et al. issued Nov. 13, 2017, which is incorporated by reference as if fully set forth herein. The embodiments described herein may be configured as described in this patent. The embodiments described herein may also be configured for setting up a metrology process as described in U.S. Pat. No. 10,267,746 to Duffy et al. issued Apr. 23, 2019, which is incorporated by reference as if fully set forth herein.

In another embodiment, the one or more functions include simulating performance of a process tool based on the 3D physical representation, as shown in step 812 of FIG. 8, and the process tool is configured for performing a process on the physical version of the specimen that intentionally alters one or more characteristics of the physical version of the specimen. For example, an additional application that is enabled by the trusted virtual system described herein is process tool simulation that takes the 3D physical model as input. Simulating the performance of the process tool may be performed using any model currently used in the art including physics-based, forward simulation models and generative DL models. In general, the process tool model may be a protected data source of a process tool manufacturer. The process tool model may be provided to the virtual system by the process tool manufacturer who can be assured that the process tool model will be received, stored, used, and discarded in a safe and secure manner by the virtual system embodiments described herein. The process tools whose performance may be simulated by the embodiments described herein may include any process tools that are configured to intentionally alter one or more characteristics of the specimen such as deposition tools, ion implantation tools, chemical-mechanical polishing tools, lithography tools, etching tools, and the like.

The process tool performance may be simulated for a number of different reasons and at different points in the manufacturing process. For example, once a semiconductor device has been designed, it is useful to know if it can be successfully fabricated. Therefore, before manufacturing begins, the embodiments described herein can be used to simulate the performance of the process tool by inputting the semiconductor device design information into a model of the process tool (directly or via one or more other functions like generating a 3D physical representation from the design information). In this manner, different protected data sources from different entities may be needed for such applications, and the embodiments described herein are configured for acquiring and using these protected data sources in a safe and secure manner.

Even after it has been determined that a semiconductor device design can be successfully manufactured, it may be useful to determine how variations in the process will affect the semiconductor devices. In this manner, a process window for the process may be established that will produce semiconductor devices having acceptable characteristics. For example, the process tool simulations may be performed with different values of one or more parameters of the process (like lithography exposure and dose) to determine one or more physical characteristics of the specimen that will be produced at the different values. Those characteristics may be analyzed to determine which values produce acceptable device characteristics. Such modeling may be combined with the electrical analysis described further herein to not only determine which process parameter values will produce physical characteristics that are acceptable but also or alternatively which process parameter values will produce electrical device characteristics that are acceptable. Therefore, such analysis may require one or more protected data sources in addition to the semiconductor device design and process tool model, all of whose safety and security can be ensured by the embodiments described herein in the same manner.

In one embodiment, the one or more functions include extracting a netlist for a device being formed on the physical version of the specimen based on the 3D physical representation, as shown in step 814 of FIG. 8. For example, one application that is enabled by the trusted virtual system described herein is netlist extraction from the 3D TCAD representation of the wafer. Extracting the netlist for the device may be performed using any commercially available or currently used method or system. In one such example, a netlist extraction method may be provided to the embodiments described herein as a protected data source, and the 3D physical representation may be input to such a method.

In a further embodiment, the one or more functions include generating an electrical representation of the netlist, as shown in step 816 of FIG. 8. In one such embodiment, the electrical representation of the netlist is a specimen scale, TCAD, electrical representation of the netlist. For example, one application enabled by the trusted virtual system is generating a wafer scale TCAD electrical (e.g., SPICE) representation of the netlist extracted from the generated 3D TCAD physical representation. Generating the electrical representation of the netlist may be performed using any commercially available or currently used method or system such as the SPICE open-source software. However, an electrical representation generation method may also be provided to the embodiments described herein as a protected data source, and the netlist may be input to such a method.

In another such embodiment, the one or more functions include permutating one or more electrical parameters of the electrical representation, as shown in step 818 of FIG. 8. For example, another application enabled by the trusted virtual system is permutations of the electrical parameters according to a DOE. In one such example, the virtual system may use a protected data source like information about test programs to perform fault modeling, fault coverage, design for test, fault injection, and the like. The test program information may include information for the parameters of the testing that is or will be done on the semiconductor devices being fabricated, like where and how testing is done. This information can then be used to infer where the semiconductor device designer, owner, manufacturer, etc. is concerned about where faults may occur. Based on that information, the electrical representation of the specimen may be modified in one or more different ways to permutate the electrical parameters of the electrical representation. One way to perform such modifications is to use a structural model to modify one or more structural characteristics of the physical representation to thereby modify one or more electrical parameters of the electrical representation. In one such example, one or more structural parameters may be modified to artificially cause a connection between two structures that would result in a short in the device. Another way to perform such modifications is to use a functional model to modify one or more functional characteristics of the physical or electrical representation to thereby modify one or more electrical parameters of the electrical representation.

Permutating the electrical parameters of the electrical representation can therefore be thought of as the reverse of permutating the physical characteristics of the physical representation. In particular, the physical structures for semiconductor devices are designed to meet electrical specifications. The physical tolerances of semiconductor structures are constrained by the acceptable variances of the resulting electrical parameters. So the physical parameters can be varied to predict the electrical parameters, but the reverse is also true that the electrical parameters can be varied to predict the physical parameters. In this manner, once the correspondence (TCAD models) between physical and electrical parameters are known, the direction of inference can be flipped, for example, by saying, for a given electrical functionality, what are the physical characteristic that could result in this.

Obviously, there are many different, commercially available models of semiconductor device faults that can be used in the embodiments described herein to permutate one or more electrical parameters of the electrical representation, and the virtual systems described herein may be configured to perform permutations of the electrical representation using any of them. The virtual systems described herein provide value beyond just being able to run the models in that they can perform functions that utilize protected data sources from different entities in a secure and safe fashion. In one such example, the electrical representation that is permutated by the virtual system may be generated from and possibly even contain protected data from the semiconductor device designer. The virtual system may use that electrical representation in combination with a fault model, which may be or include protected data, from a different entity to permutate the electrical representation. That permutated electrical representation may then be used to generate additional information that can be output in a manner that protects the data of the first two entities. For example, the virtual system may use information from another entity about an electrical tester to generate a testing program for the semiconductor device based on the permutated electrical representation. That testing program may not include any information about the electrical representation or the permutated electrical representation thereby enabling the electrical tester operator to test the semiconductor devices without having or needing access to the protected data sources from the semiconductor device designer and the fault model developer. In this manner, the embodiments described herein can overcome domain boundaries that are typically in place for practical reasons in addition to IP reasons.

As noted elsewhere herein, the one or more functions performed by the virtual system with two or more protected data sources may be performed in addition to or in combination with a virtual version of a process performed by the actual system. The embodiments described herein therefore can extend the functionality and usefulness of a virtual system like a virtual inspector by taking advantage of the trusted nature of the embodiments described herein. For example, electrical faults can be functional (typically caused by a defect) or parametric (typically due to variations found with metrology). Many inspection systems currently on the market are primarily concerned with how the specimen appears in images to thereby look for defects that may or may not cause actual problems for the functionality of the semiconductor devices. By extending the functionality of a virtual inspector beyond just inspection to include functionality related to electrical fault consideration/examination for semiconductor devices, the embodiments can generate and provide important information about not only how the specimen looks, but also about how the devices being formed on or with the specimen work electrically. The functionality of other systems described herein such as virtual and actual metrology systems can be extended in the same way. The embodiments described herein thereby bridge the physical and electrical spaces by enabling multiple protected data sources from different entities to be used separately or in combination on a single system in a secure and safe manner.

The trusted virtual system embodiments described herein enable design-technology co-optimization (DTCO) experiments to be done in research and development environments. Whereas today these activities are compartmentalized, the embodiments described herein enable a digital twin virtual inspection of a specimen along with real specimen recordings and can run real time experiments of the whole DTCO flow that otherwise takes weeks/months to do physically.

The embodiments described herein can therefore benefit many of the parties in the semiconductor device manufacturing ecosystem. Semiconductor device designers can better learn what works or doesn't work by allowing their protected data to be used in the virtual systems described herein without worrying about the safety and security of their data thereby enabling the designers to develop better future designs. Inspection tool manufacturers can create better inspection processes and tools based on information from other parties such as semiconductor device designers thereby increasing the value of their contribution to the manufacturing process and possibly developing better systems and methods for future tools. In the same way, process tool, metrology tool, and electrical testing tool manufacturers can generate better tools and processes. The yield of existing tools and processes can be improved in this manner, and the development of new tools and processes can be made easier, quicker, and cheaper with greater chances of success. In general then, by breaking down barriers that currently prevent different entities from allowing the use of their protected data sources by other entities, the embodiments described herein can provide advantages and improvements for nearly every sector of the semiconductor manufacturing ecosystem.

In an additional embodiment, the one or more functions include injecting a fault into the electrical representation, as shown in step 820 of FIG. 8. For example, an additional application enabled by the trusted virtual system is fault injection into this representation (e.g., using a SPICE model of faults). In one such example, the virtual system may use a protected data source like information about test programs to perform fault injection. The virtual system may perform fault injection in the same manner described above with respect to permutating the electrical parameter(s).

In some embodiments, the one or more functions include generating a virtual static test of the electrical representation to find static faults, as shown in step 822 of FIG. 8. For example, a further application enabled by the trusted virtual system is a virtual static test of the electrical representation to find static (DC) faults. In one such example, the virtual system may use a protected data source like information about test programs to perform fault modeling, fault coverage, and the like. In this manner, the virtual system may in some embodiments be a virtual tester with the right inputs.

In another embodiment, the one or more functions include generating a virtual functional test of the electrical representation to find parametric faults, as shown in step 824 of FIG. 8. For example, another application enabled by the trusted virtual system is a virtual functional test of the electrical representation to find parametric (AC) faults. In one such example, the virtual system may use a protected data source like information about test programs to perform fault modeling, fault coverage, and the like. In this manner, the virtual system may in some embodiments be a virtual tester with the right inputs.

All of the embodiments described herein may be configured for storing results of one or more steps performed by the embodiments in a computer-readable storage medium. The results may include any of the results described herein and may be stored in any manner known in the art. The storage medium may include any storage medium described herein or any other suitable storage medium known in the art. After the results have been stored, the results can be accessed in the storage medium and used by any of the method or system embodiments described herein, formatted for display to a user, used by another software module, method, or system, etc.

Such functions include, but are not limited to, altering a process such as a fabrication process or step that was or will be performed on the specimen in a feedback or feedforward manner. For example, the virtual system may be configured to determine one or more changes to a process that was performed on a specimen inspected as described herein and/or a process that will be performed on the specimen based on the detected defect(s). The changes to the process may include any suitable changes to one or more parameters of the process. The virtual system preferably determines those changes such that the defects can be reduced or prevented on other specimens on which the revised process is performed, the defects can be corrected or eliminated on the specimen in another process performed on the specimen, the defects can be compensated for in another process performed on the specimen, etc. The virtual system may determine such changes in any suitable manner known in the art.

Those changes can then be sent to a semiconductor fabrication system (not shown) or a storage medium (not shown) accessible to the virtual system and the semiconductor fabrication system. The semiconductor fabrication system may or may not be part of the system embodiments described herein. For example, the virtual system may be coupled to the semiconductor fabrication system, e.g., via one or more common elements such as a housing, a power supply, a specimen handling device or mechanism, etc. The semiconductor fabrication system may include any semiconductor fabrication system known in the art such as a lithography tool, an etch tool, a chemical-mechanical polishing (CMP) tool, a deposition tool, and the like.

Each of the embodiments of each of the systems described above may be combined together into one single embodiment.

Another embodiment relates to a computer-implemented method for performing one or more functions with protected data sources from different entities. The method includes performing one or more functions for a specimen with two or more protected data sources from two or more different entities, respectively. The method also includes performing a virtual version of a process capable of being performed by an actual system with output generated by the actual system for a physical version of the specimen while the specimen is disposed within the actual system. The one or more functions and the virtual version of the process are performed by a virtual system coupled to the actual system to thereby receive the output generated by the actual system for the physical version of the specimen. The virtual system includes at least a computer system and a storage medium. The virtual system is not capable of having the physical version of the specimen disposed therein.

Each of the steps of the method may be performed as described further herein. The method may also include any other step(s) that can be performed by the system embodiments described herein. In addition, the method described above may be performed by any of the system embodiments described herein.

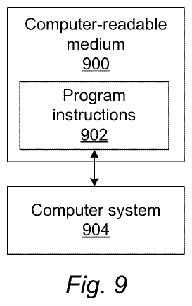

An additional embodiment relates to a non-transitory computer-readable medium storing program instructions executable on a computer system for performing one or more functions with protected data sources from different entities. One such embodiment is shown in FIG. 9. In particular, as shown in FIG. 9, non-transitory computer-readable medium 900 includes program instructions 902 executable on computer system 904. The computer-implemented method may include any step(s) of any method(s) described herein.

Program instructions 902 implementing methods such as those described herein may be stored on computer-readable medium 900. The computer-readable medium may be a storage medium such as a magnetic or optical disk, a magnetic tape, or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), SSE (Streaming SIMD Extension) or other technologies or methodologies, as desired.

Computer system 904 may be configured according to any of the embodiments described herein.

Further modifications and alternative embodiments of various aspects of the invention will be apparent to those skilled in the art in view of this description. For example, methods and systems for performing functions with protected data sources from different entities are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A system configured for performing one or more functions with protected data sources from different entities, comprising:
a virtual system coupled to an actual system to thereby receive output generated by the actual system for a physical version of a specimen while the specimen is disposed within the actual system, wherein the virtual system comprises at least a computer system and a storage medium, wherein the virtual system is not capable of having the physical version of the specimen disposed therein, and wherein the virtual system is configured for:
performing one or more functions for the specimen with two or more protected data sources from two or more different entities, respectively; and
performing a virtual version of a process capable of being performed by the actual system for the physical version of the specimen.

2. The system of claim 1, wherein the virtual system is further configured as a virtual inspector.

3. The system of claim 1, wherein the virtual system is further coupled to the actual system by a local network.

4. The system of claim 1, wherein the virtual system is further configured for receiving the two or more protected data sources on two or more encrypted and isolated data paths, respectively, and for storing the two or more protected data sources on two or more encrypted and isolated portions, respectively, of the storage medium.

5. The system of claim 1, wherein the virtual system is further configured for performing the one or more functions using homomorphic encryption.

6. The system of claim 1, wherein the virtual system is further configured for generating output of the one or more functions and providing the output to a first of the two or more different entities without exposing any of the two or more protected data sources not from the first of the two or more different entities.

7. The system of claim 1, wherein the virtual system is further configured for securely disposing of the two or more protected data sources after performing the one or more functions.

8. The system of claim 1, wherein the virtual system is further configured for restricting control of hardware encryption keys for the two or more protected data sources to only the two or more different entities, respectively.

9. The system of claim 1, wherein the virtual system is further configured for third party verification of safety of the two or more protected data sources within at least the computer system and the storage medium of the virtual system.

10. The system of claim 1, wherein the virtual system is further configured for enforcing safety of the storage medium via the Rust programming language.

11. The system of claim 1, wherein performing the one or more functions comprises performing a first of the one or more functions using at least two of the two or more protected data sources.

12. The system of claim 1, wherein performing the one or more functions comprises performing a first of the one or more functions using only a first of the two or more protected data sources and for performing a second of the one or more functions using only a second of the two or more protected data sources.

13. The system of claim 1, wherein the virtual system is further configured for performing the virtual version of the process using output of at least one of the one or more functions.

14. The system of claim 1, wherein performing the one or more functions comprises performing a first of the one or more functions for the specimen with at least one of the two or more protected data sources in combination with results generated by performing the virtual version of the process.

15. The system of claim 1, wherein the one or more functions comprise generating a three-dimensional physical representation of the physical version of the specimen.

16. The system of claim 15, wherein the three-dimensional physical representation is a specimen scale, three-dimensional, technology computer-aided design, physical representation of the physical version of the specimen.

17. The system of claim 15, wherein the one or more functions further comprise one or more of: injecting a defect into the three-dimensional physical representation; permutating dimensions of one or more features in the three-dimensional physical representation; simulating performance of an inspection system based on the three-dimensional physical representation; simulating performance of a metrology system based on the three-dimensional physical representation; and simulating performance of a process tool based on the three-dimensional physical representation, and wherein the process tool is configured for performing a process on the physical version of the specimen that intentionally alters one or more characteristics of the physical version of the specimen.

18. The system of claim 15, wherein the one or more functions further comprise extracting a netlist for a device being formed on the physical version of the specimen based on the three-dimensional physical representation.

19. The system of claim 18, wherein the one or more functions further comprise generating an electrical representation of the netlist.

20. The system of claim 19, wherein the electrical representation of the netlist is a specimen scale, technology computer-aided design, electrical representation of the netlist.

21. The system of claim 19, wherein the one or more functions further comprise one or more of: permutating one or more electrical parameters of the electrical representation; injecting a fault into the electrical representation; generating a virtual static test of the electrical representation to find static faults; and generating a virtual functional test of the electrical representation to find parametric faults.

22. A non-transitory computer-readable medium, storing program instructions executable on a computer system for performing one or more functions with protected data sources from different entities, wherein the computer-implemented method comprises:
performing one or more functions for a specimen with two or more protected data sources from two or more different entities, respectively; and
performing a virtual version of a process capable of being performed by an actual system with output generated by the actual system for a physical version of the specimen while the specimen is disposed within the actual system, wherein the one or more functions and the virtual version of the process are performed by a virtual system coupled to the actual system to thereby receive the output generated by the actual system for the physical version of the specimen, wherein the virtual system comprises at least the computer system and a storage medium, and wherein the virtual system is not capable of having the physical version of the specimen disposed therein.

23. A computer-implemented method for performing one or more functions with protected data sources from different entities, comprising:
performing one or more functions for a specimen with two or more protected data sources from two or more different entities, respectively; and
performing a virtual version of a process capable of being performed by an actual system with output generated by the actual system for a physical version of the specimen while the specimen is disposed within the actual system, wherein the one or more functions and the virtual version of the process are performed by a virtual system coupled to the actual system to thereby receive the output generated by the actual system for the physical version of the specimen, wherein the virtual system comprises at least a computer system and a storage medium, and wherein the virtual system is not capable of having the physical version of the specimen disposed therein.
